(19) United States
(12) Patent Application Publication
(10) Pub. No.: US 2005/0075924 A1
(43) Pub. Date: Apr. 7, 2005

(54) Shuttle and car delivery service

(76) Inventors: Garrett M. Greenlee, Westerville, OH (US); Scott A. Messing, Pickerington, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/886,489

(22) Filed: Jul. 7, 2004

Related U.S. Application Data
(60) Provisional application No. 60/485,133, filed on Jul. 7, 2003.

(51) Int. Cl. G06F 17/60

(52) U.S. Cl. 705/13

(57) ABSTRACT

A method for a shuttle and car delivery service at a venue. The method comprises the steps of transferring ignition keys for a car in the possession of the customer from the customer to an operator of the service, transporting the customer from the venue to a customer destination, and separately transporting the car from the venue to a car destination. The method provides a way to prevent the customer from driving while incapacitated, without requiring the customer to retrieve the vehicle once the customer is able to operate the vehicle.

This application claims priority to U.S. provisional application 60/485,133, filed Jul. 7, 2003, the contents of which are hereby incorporated by reference.

### FIELD

This invention relates to a system and method for providing a shuttle and car delivery service. In particular, this invention relates to a system and method for ensuring the safe transport of customers and vehicles to actively prevent the customers from driving while incapacitated.

### BACKGROUND

Many retail businesses cater to customers who patronize the establishment and stay for an extended period of time, taking advantage of the products and services offered. Some establishments, such as entertainment venues, may derive least a portion of their revenue from the sale of alcoholic beverages. Such establishments inevitably need to deal with inebriated customers.

A prudent step for handling inebriated customers is to stop serving them alcoholic beverages. In such situations the establishment may also offer to call a cab service for the customer. However, in many cases the customer decides to drive themselves home, as he or she does not want to leave their car behind or deal with the inconvenience of retrieving the car at a later time. Other concerns, such as the security of the car, parking tickets and towing may also factor into the customer's decision to drive.

A popular solution is for a group of customers to designate a driver, who agrees not to consume alcoholic beverages. However, this method is subject to failure, as the designated driver may subsequently decide to consume in spite of the agreement, leaving the group with no safe means of getting home. Similarly, some customers may not plan to partake of alcoholic beverages when driving to the establishment, yet may find themselves incapacitated at the end of the evening.

Yet another solution is for the customers to make prior arrangements for a non-participating friend or family member to pick up them up. This solution suffers from several potential drawbacks, such as variations in the reliability and promptness of the person providing the transportation, and vehicle reliability. In addition, the customer must make arrangements to retrieve the car or make arrangements for at least two persons to participate in the pick-up so that one person can transport the customer while the other drives the customer's car. Still another drawback is the need to set a pre-arranged time, or to call for the ride and wait for the ride to arrive.

In some situations customers may not consume alcoholic beverages at all, but would still prefer not to drive themselves to and from the establishment for a variety of reasons, such as safety, convenience, and traffic congestion. Many such customers will not take cabs due to poor service, and may decide not to visit the establishment at all.

The inconvenience of taxi service and the need to plan ahead for travel arrangements, combined with impaired thought processes due to inebriation, can lead to tragic consequences for the customer and/or innocent bystanders. There is a need for a safe, reliable and convenient means for transporting customers to and from establishments and for transporting their vehicles from the establishment to a convenient location.

### SUMMARY

A system and method for transporting customers and their cars is disclosed according to an embodiment of the present invention. The customer drives to the establishment, parks his or her car, then registers for a shuttle service and hands over the car keys to the establishment. The customer enjoys the products and services provided by the venue, and is free to responsibly consume alcoholic beverages. When the customer is ready to depart the venue, a shuttle returns the customer to their home or another desired destination. A driver separately transports the customer's car to the customer's home or another appointed place, and the keys are left in a designated location. The driver is then picked up by the shuttle and returned to the establishment to serve other customers. Alternatively, the driver may return to the establishment using a small vehicle which can be carried by the customer's car.

An object of the present invention is a method for operating a shuttle and car delivery service at a venue. The method comprises the steps of transferring ignition keys for a car in the possession of the customer from the customer to an operator of the service, transporting the customer from the venue to a customer destination, and separately transporting the car from the venue to a car destination.

Another object of the present invention is a method for operating a customer shuttle to and from a venue. The method comprises the steps of registering a customer for transportation to and from the venue, transporting the customer from a predetermined location to the venue, and transporting the customer from the venue to a predetermined destination. The method may additionally include the steps of tallying the number of registrations during a predetermined period of time, tallying the number of customers at the venue during the time period, and using the tallies to forecast the amount of business at the venue.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a flow diagram of a system and method for transporting customers and their cars from an establishment according to an embodiment of the present invention; and

FIG. 2 is a flow diagram of a system and method for transporting customers to and from an establishment according to an alternate embodiment of the present invention.

### DETAILED DESCRIPTION

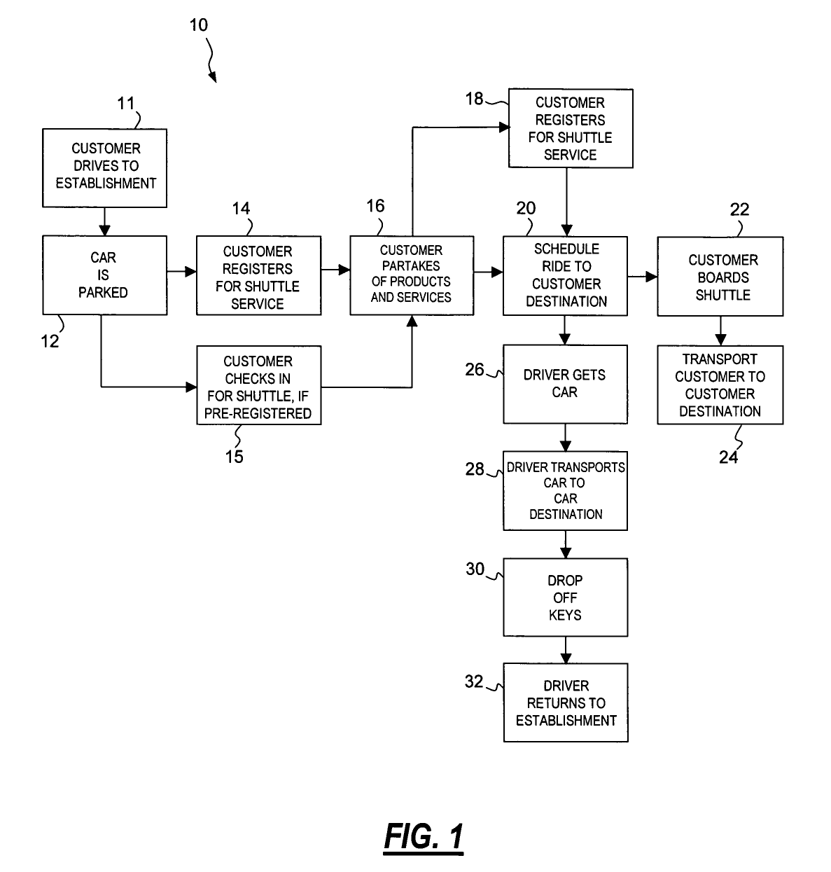

A system and method 10 for transporting customers and their cars from an establishment is shown in FIG. 1 according to an embodiment of the present invention. It should be noted that “customer” as used herein is intended to apply generally to a customer of a venue, with or without a car. If the customer is associated with a car, the driver and any other occupants of the car may be considered to be a customer. Likewise, the term “passenger” may be used interchangeably with “customer.”

At step 11 a customer drives his or her car to the establishment and parks his or her car at step 12. The car may be parked in a public parking space or a garage in proximity to the establishment, or may be parked in a parking space provided by the establishment. Alternatively, the customer may leave the car with a valet service at an entrance to the establishment.

The customer may register for a shuttle service upon arrival at step 14, giving an attendant pertinent information including, but not limited to, customer name, address, home phone number, mobile phone number, location where keys are to be left, the number of customers to be transported, customer destination(s), and car delivery location.

In an alternate embodiment of the present invention, the customer may pre-register at least a portion of the information of step 14, as depicted at step 15. The establishment may record and store the information for continuing use on future visits, allowing the customer upon arrival to merely check in with the service at step 15. This may be advantageous if the customer regularly patronizes the establishment, adding a measure of convenience and time-savings for both the establishment and the customer. In still another alternate embodiment of the present invention, the customer may subscribe to a shuttle service used by a plurality of establishments, providing the customer with convenient and rapid check-in at those establishments. In yet another embodiment of the present invention, the customer may pre-register with or subscribe to a shuttle service that operates independently of any particular establishment.

Steps 14 and 15 may include a provision wherein the customer is not permitted to cancel the service and retrieve his or her keys after registration or check-in. This prevents the customer from changing their mind while their judgment is impaired and attempting to drive while incapacitated. Pre-arrangements may optionally be made to transfer the keys from the establishment to a third party.

At step 16 the customer enjoys the offerings of the establishment including, for example, various forms of visual and aural entertainment, food and beverages, including alcoholic beverages.

If the customer did not register for shuttle service upon arrival at step 14, the customer may subsequently register for the service at any time while at the establishment, as indicated at step 18. During step 18 the customer provides an attendant with the necessary information as discussed above for step 14.

At any time during the visit the customer may schedule a departure time for a shuttle ride to a designated destination, as at step 20. The shuttle service may be configured to depart on-demand or by appointment, or may be configured to depart at pre-determined or regular times, such as hourly. If a plurality of customers arrived in the car at step 11 they may each be transported to a common destination or to different destinations, at the same time, or at different times. At step 22 the customer boards the shuttle and at step 24 is returned to their designated destination, such as their home.

The customer's car is obtained by a driver for the service at step 26 and is separately transported to a previously-designated destination by the driver at step 28. The customer's car may be transported to the designated destination at any time. In various embodiments the car may be transported concurrently with (but separately from) the customer, earlier, or at a later time. Delivering the car at a later time may deter the customer from subsequently using the car after delivery while still incapacitated. Delivering the car at a non-concurrent time provides the shuttle service with a greater time span for delivery, reducing the number of drivers required at any given time. Another advantage of non-concurrent car delivery is that the car may be during lull times for the shuttle, allowing the shuttle to return delivery drivers to the establishment.

The driver leaves the car keys at a pre-determined location at step 30. Example locations include a secured box, a mail slot, or a third party who may optionally ensure that the customer cannot access the keys while still incapacitated.

At step 32 the driver returns to the establishment. Return may be accomplished by the shuttle picking up the driver, particularly for situations where car delivery is concurrent with customer drop-off. In an alternate embodiment the driver may be provided with a small vehicle that can be temporarily stored in or on the customer's car. Example vehicles include gas and electric motor scooters, and fixed-frame and folding-frame bicycles.

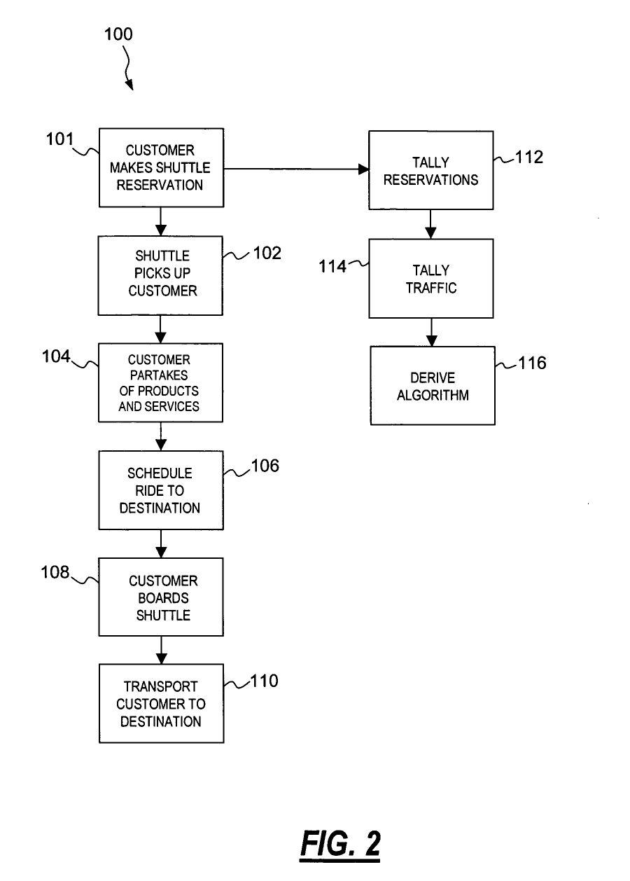

A system and method 100 for transporting customers according to an alternate embodiment of the present invention is depicted in FIG. 2 wherein the customer may be provided with a round-trip transportation service. At step 101 the customer makes a shuttle reservation. The reservation may be an appointment for a future time and date, or may be on-demand for pickup. At step 102 the shuttle picks up the customer at a time and location designated in the reservation and transports them to the establishment. At step 104 the customer enjoys the offerings of the establishment, including, for example, various forms of visual and aural entertainment, food and beverages, including alcoholic beverages. At any time during the visit, the customer may schedule a departure time for transport to a previously-designated destination, as at step 106. The shuttle service may be configured to depart by appointment or on-demand, or may be configured to depart at pre-determined times, such as hourly. At step 108 the customer boards the shuttle, and is returned to their designated destination, such as their home, at step 110. This embodiment allows the customer to enjoy the products and services of the establishment without concern for traffic, parking, security, and driving under the influence.

The number of reservations made at step 101 during a predetermined period of time may be tallied by the venue at step 112 and used as a predictive element for statistical data relevant to the venue. The number of reservations for a particular period of time may be combined with other relevant data such as a total count of customer traffic at the venue during the time period at step 114. In addition, other factors such as customer demographic data, the amount of revenue generated during the time period, the purchase of particular goods and services during the time period, types of entertainment, seasonal variations, and so on, may be used to derive at step 116 predictive data such as an algorithm to forecast business data. Business data may include, without limitation, the number and types of customers (i.e., families, adults, couples, singles), revenue, and amounts and types of goods and services ordered. This business data may be applied in a variety of ways including, without limitation, allocating a sufficient number of transportation vehicles and drivers at various times, ordering supplies, and scheduling venue staff.

Detailed data provided with the reservations may also be used to derive additional business data, such as algorithms, for forecasting. For example, the pick-up times listed in the reservations may also be used to allocate transportation vehicles and drivers commensurate with the expected demand at various times within a predetermined period of time, such as peak and lull hours at various days of the week and during special events such as scheduled entertainment at the venue.

The predictive data may be used manually, such as in the form of lists, tables, graphs and charts, or may be made part of a computer program installed into a computer and adapted to provide predictions based on predetermined criteria, including, without limitation, days of the week, season, weather, entertainment type, time of day, events at the venue, events in the area surrounding the venue, special offerings at the venue, advertising.

It should be noted that the establishment may be any type or form of business. In other embodiments the method may be beneficially employed by a medical facility for patients receiving outpatient surgery or other treatment that leaves the patient temporarily incapacitated.

It should be further noted that the present invention may take on a number of alternate embodiments wherein the system and method may include various enhancements. For example, video and audio recordings of the interior of shuttles may be made when customers are aboard, to provide an added measure of safety and security for the customers and the shuttle driver. In addition, navigation aids such as a global positioning satellite (GPS) system may be utilized to more efficiently locate car delivery and customer destinations. Conventional radio communication equipment may also be utilized to coordinate the operation of shuttles and car drivers, and direct them as needed.

The present invention may be employed by the establishment as a revenue-generating and/or goodwill effort. Alternatively, the present invention may be employed by an individual or entity separate from the establishment. Further, the present invention may be customer-focused rather than venue-focused wherein a plurality of customers may subscribe to a service utilizing the present invention. In this embodiment it is anticipated that subscribers may visit any of a plurality of venues and call upon the service when desired.

While this invention has been shown and described with respect to a detailed embodiment thereof, it will be understood by those skilled in the art that various changes in form and detail thereof may be made without departing from the scope of the claims of the invention.

1. A method for operating a shuttle and car delivery service at a venue, comprising the steps of:
transferring ignition keys for a car in the possession of a customer from the customer to an operator of the service;
transporting the customer from the venue to a customer destination; and
separately transporting the car from the venue to a car destination.

2. The method of claim 1, further comprising the steps of:
determining a departure time for the customer;
determining a delivery time for the car;
transporting the customer from the venue to the customer destination proximate the customer departure time; and
separately transporting the car from the venue to the car destination proximate the car delivery time.

3. The method of claim 2 wherein the customer departure time is one of a predetermined time, a regularly scheduled time, and upon demand of the customer.

4. The method of claim 2 wherein at least one of the customer departure time, customer destination, car delivery time, and car destination are determined upon the customer's arrival at the venue.

5. The method of claim 2 wherein at least one of the customer departure time, customer destination, car delivery time, and car destination are determined at a time subsequent to the customer's arrival at the venue.

6. The method of claim 1, further comprising the steps of:
determining a drop-off location for the ignition keys; and
delivering the ignition keys to the drop-off location after transporting the car.

7. The method of claim 1, further comprising the step of providing a driver to transport the car to the car destination.

8. The method of claim 7, further comprising the step of providing return transportation for the driver after transporting the car to the car destination.

9. The method of claim 8 wherein the return transportation is one of a shuttle, a motor scooter carried with the car, and a bicycle carried with the car.

10. The method of claim 1 wherein the car is transported one of concurrent with transportation of the customer, prior to transportation of the customer, and subsequent to transportation of the customer.

11. The method of claim 1 wherein the car transportation portion of the service cannot be cancelled once the ignition keys are transferred from the customer to the operator.

12. The method of claim 1 wherein the service is associated with the venue.

13. The method of claim 1 wherein the service operates independently of the venue and services a plurality of venues.

14. The method of claim 1, further including the step of serving alcoholic beverages to the customer.

15. A method for operating a shuttle and car delivery service at a venue, comprising the steps of:
determining a departure time and a destination for a customer;
determining a delivery time and a destination for a car in the possession of the customer;
determining a drop-off location for the ignition keys;
transferring ignition keys for the car from the customer to an operator of the service;
transporting the customer from the venue to the customer destination proximate the customer departure time;
providing a driver to transport the car from the venue to the car destination;
separately transporting the car from the venue to the car destination proximate the car delivery time;
delivering the ignition keys to the drop-off location after transporting the car; and
providing return transportation for the driver after transporting the car to the car destination.

16. A method for operating a customer shuttle and car delivery service at a venue, comprising the steps of:
pre-registering a customer for the service;
checking in the customer for the service;
transferring ignition keys for the car from the customer to an operator of the service;
transporting the customer from the venue to the customer destination proximate the customer departure time; and
separately transporting the car from the venue to the car destination proximate the car delivery time.

17. A method for operating a customer shuttle to and from a venue, comprising the steps of:
registering a customer for transportation to and from the venue;
transporting the customer from a predetermined location to the venue; and
transporting the customer from the venue to a predetermined destination.

18. The method of claim 17, further including the steps of:
tallying the number of registrations during a predetermined period of time;
tallying the number of customers at the venue during the time period; and
using the tallies to forecast business data.

19. The method of claim 18, further including the step of allocating a number of shuttle vehicles to be available during a predetermined period of time, based on the business data.

20. The method of claim 18, further comprising the step of using a computer program installed within a computer to forecast the business data.

21. The method of claim 18, further including the step of using at least one of lists, charts, graphs and tables to forecast the business data.
